(19) United States
(12) Patent Application Publication
(10) Pub. No.: US 2006/0157463 A1
(43) Pub. Date: Jul. 20, 2006

(54) Food preparation device

(76) Inventors: Melissa A. Wiele, Granite Bay, CA (US); Scott M. Wiele, Granite Bay, CA (US); Richard A. Deaver, Broken Arrow, OK (US)

Correspondence Address: LITMAN LAW OFFICES, LTD, PO BOX 15035, CRYSTAL CITY STATION, ARLINGTON, VA, 22215, US

(21) Appl. No.: 11/034,748

(22) Filed: Jan. 14, 2005

(51) Int. Cl. A47J 31/41; B67D 5/63

(52) U.S. Cl. 219/214; 392/441; 222/146.5

(57) ABSTRACT

The food preparation device is a countertop appliance that receives and holds water and dry powder, such as dry baby formula powder, for preparing multiple quantities of food. The device measures and dispenses an exact pre-determined amount of dry powder in response to directions disclosed on an interface device via volume input controls and also measures, heats and dispenses an exact amount of water in response to temperature input controls. Generally, the water is prepared by heating it to body temperature, but can be adjusted by manipulating the temperature input controls. In use a user, after ensuring the device is filled with the powder and water, selects a volume and a temperature, if desired, for preparing food and the device automatically prepares the exact amount desired.

### BACKGROUND OF THE INVENTION

1. Field of the Invention

The present invention relates to food preparation devices, and more particularly, to a device that prepares food by mixing a dry food powder with heated water, e.g., a device that prepares and warms a baby bottle from dry formula.

2. Description of the Related Art

Preparing dry baby formula is a time consuming task. The process requires a number of steps, such as measuring a quantity of powder formula, boiling water, mixing the boiled water with the formula, and most importantly, checking the temperature of the ultimate product. Time is a critical factor, especially when a baby is crying because of hunger. In order to appease the crying baby, the formula must be made expeditiously and at an appropriate temperature to prevent burning the baby's mouth. A device is desired that will measure an appropriate quantity of dry baby formula powder, and heat a corresponding appropriate amount of water to any desired temperature in preparing baby food. Although well suited for preparing a bottle of baby formula, the present device may also be used for preparing any food or beverage that may be prepared by mixing a dry powder with heated water. Thus, a food preparation device solving the aforementioned problems is desired.

### SUMMARY OF THE INVENTION

The food preparation device is a countertop appliance that receives and holds water and dry powder, such as dry baby formula powder, for preparing multiple quantities of food. The device has a water pump, a water heating element, a dry formula hopper, a hopper vibrator, a dispenser assembly and an interface device displaying visual indicators and control buttons, such as temperature input controls and volume input controls. The dispenser assembly dispenses powder and water. The dispenser assembly includes a hopper-dispenser assembly for dispensing the dry powder that measures and dispenses a pre-determined amount of dry powder in response to directions communicated to the interface device by the volume input controls.

Prior to dispensing water, water must be obtained from a source, such as a water reservoir, measured in response to volume input controls, and heated. Once the water is obtained, the water pump propels the water to the heating element. As water flows into the heating element, a check valve disposed on the heating element closes and the heating element becomes pressurized, causing the water to be heated to the appropriate temperature as it flows thru the heating element. The water is dispensed from the heating element through a water outlet tube. The water outlet tube forms the dispenser assembly for dispensing water into a baby bottle.

The amount of water pumped to the heating element and that is eventually dispensed is an exact measured volume that is calculated by the rate of water flow and the time during which the pump is turned on. The pump is selectively turned on by a timer. A restrictor valve disposed on the water outlet tube controls the flow rate of water. The exact volume amount of water is therefore obtained by multiplying the amount of time the pump is turned on with the rate at which the water flows through the device. The equation is for the above principle is:

$$Water flow rate \times time pump is operational = measured amount of water .$$

Thus, if the flow rate of water is one ounce per ten seconds, then the pump must be active for twenty seconds to pump a volume of two ounces. The restrictor valve and the check valve not only work in conjunction with each other to control the rate of water in measuring the exact volume of water to dispense, but also function in helping to heat the water by maintaining a constant pressure in the heating element.

The water is generally prepared by heating it to body temperature. The temperature at which the water is prepared can be adjusted to higher or lower temperatures by manipulating the temperature input controls on the interface device. The interface device also has visual indicators to indicate water level. One such indicator is a low water indicator that determines low water levels in the water reservoir. In other embodiments, a timer may be installed to automatically prepare the baby formula at designated times. In some embodiments the device may have a water reservoir for storing water, while in other embodiments the device may have a direct connection to an external water source.

In use, a user adjusts the input controls to prepare formula, or other food prepared from dry powder, by selecting a volume from the volume input controls. The temperature value need not be selected, since the device is set by default to heat water to body temperature, but may be adjusted to a desired temperature by manipulating the temperature input controls. Thus, once the volume selection is made the device is fully automatic. The device dispenses formula in predetermined volumes, such as 2 ounces, 4 ounces, 6 ounces and 8 ounces. Upon selection of the desired amount, visual indicators, such as light emitting diodes, illuminate the volume and temperature selections, as well as a brewing indicator to indicate that the device is operating.

Upon selecting the desired volume to be prepared, the dry powder is agitated out of the hopper by the hopper vibrator into a hopper-dispenser assembly that measures and dispenses dry formula. The dry formula is dispensed into the bottle attached to the device. The selection made on the interface device also initiates the preparation and dispensation of water.

Water is pumped out of the water reservoir by the water pump into the water heating element. The water is heated as it flows through the heating element, reaching the appropriate temperature and being dispensed from the heating element via the water outlet tube. The water is dispensed into the bottle after the powder in order to ensure proper mixing and to prevent the formula from congealing or forming lumps in the bottle. Nowhere in the device do the water and the dry formula meet; the only time the two are mixed is in the bottle that is removably attached to the device. Therefore, the device may require less maintenance in cleaning, since the food preparation components, the dry powder and the water, only mix in the receiving bottle.

These and other features of the present invention will become readily apparent upon consideration of the following specification and drawings.

### BRIEF DESCRIPTION OF THE DRAWINGS

FIG. 1 is an environmental, perspective view of a food preparation device according to the present invention.

FIG. 2 is a side view of the food preparation device according to the present invention with the housing in phantom to display interior components.

FIG. 3 is a perspective view of a formula dispenser in the food preparation device according to the present invention.

FIG. 4 is a front view of the food preparation device according to the present invention with the housing in phantom to display interior components.

FIG. 5 is a block diagram showing the circuitry used in the food preparation device according to the present invention.

Similar reference characters denote corresponding features consistently throughout the attached drawings.

### DETAILED DESCRIPTION OF THE PREFERRED EMBODIMENTS

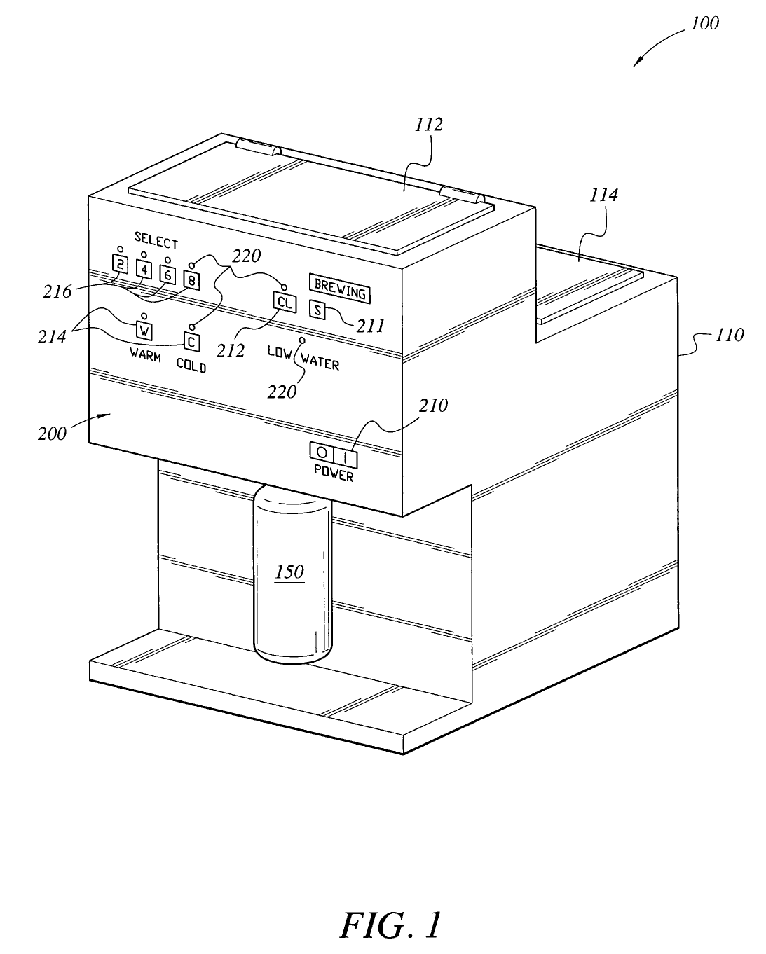

The present invention is a food preparation device, designated in the drawings as 100. FIG. 1 shows the device 100 holding a bottle 150. The device has a housing 110 that includes an interface device 200 disposed on the housing 110 having visual indicators 220 and a plurality of control buttons, such as temperature input controls 214, volume input controls 216, an on/off switch 210, a clear control button 212 and a start control button 211. The device 100 removably receives a bottle 150 to directly dispense food into the bottle 150. The device 100 receives and stores water and dry powder, such as dry baby formula powder, for preparing multiple quantities of food.

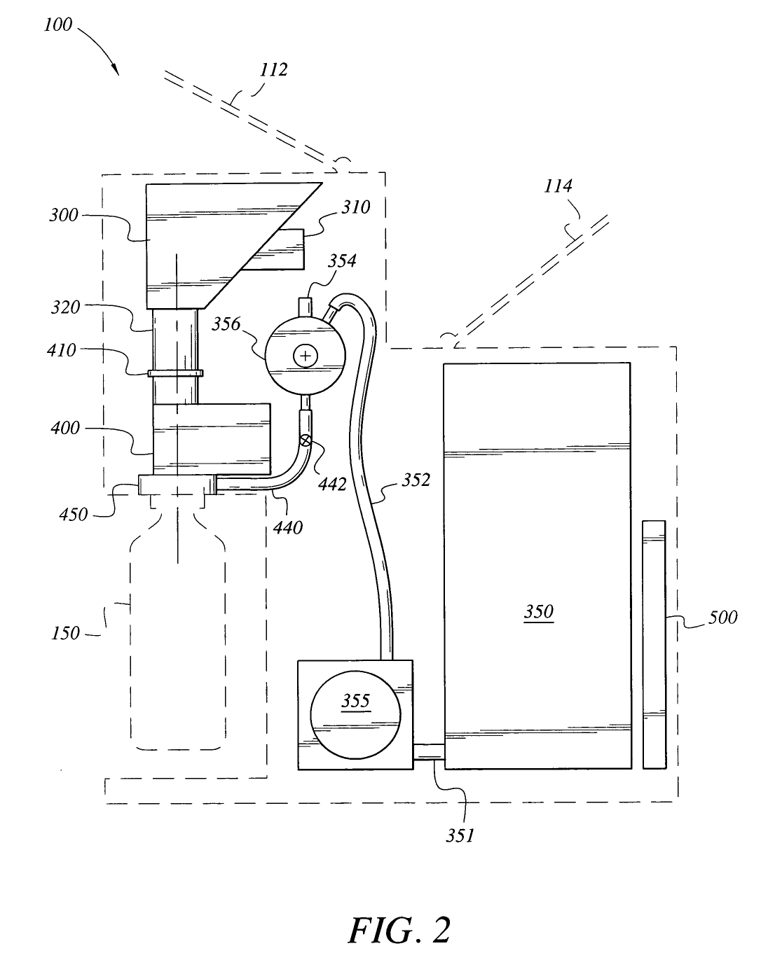

Referring to FIG. 2, dry powder is placed into a hopper 300 through door 112 and water is poured into a water reservoir 350 via door 114. The device 100, however, may have alternate ways to obtain water, such as by connecting the device 100 to an outside water source, thereby foregoing the need for the water reservoir 350. Both the hopper 300 and the water reservoir 350 hold enough supplies to prepare more than one eight ounce bottle of food. Preferably, the water reservoir 350 will hold enough water for a twenty-four hour period, having a capacity to hold about 150 cubic inches or 81 ounces of water. The water reservoir 350 should also have a water level sensor 530 that detects if the water level is low, setting off one of the visual indicators 220 on the interface device 200. After the hopper 300 is filled with powder and the water reservoir 350 is filled with water, the device is ready for dispensing when directed by the input controls 214, 216.

FIGS. 2, 3 and 4, show a dispenser assembly for dispensing the dry powder and heated water into the bottle 150 at a temperature and a volume set by the input controls 214, 216. For dispensing powder, the dispenser assembly comprises the hopper 300, a hopper vibrator 310, a hopper transition conduit 320, a hopper rest 410, and a hopper dispenser assembly 400 for measuring and dispensing pre-determined amounts of dry powder in response to directions communicated by the volume input controls 216.

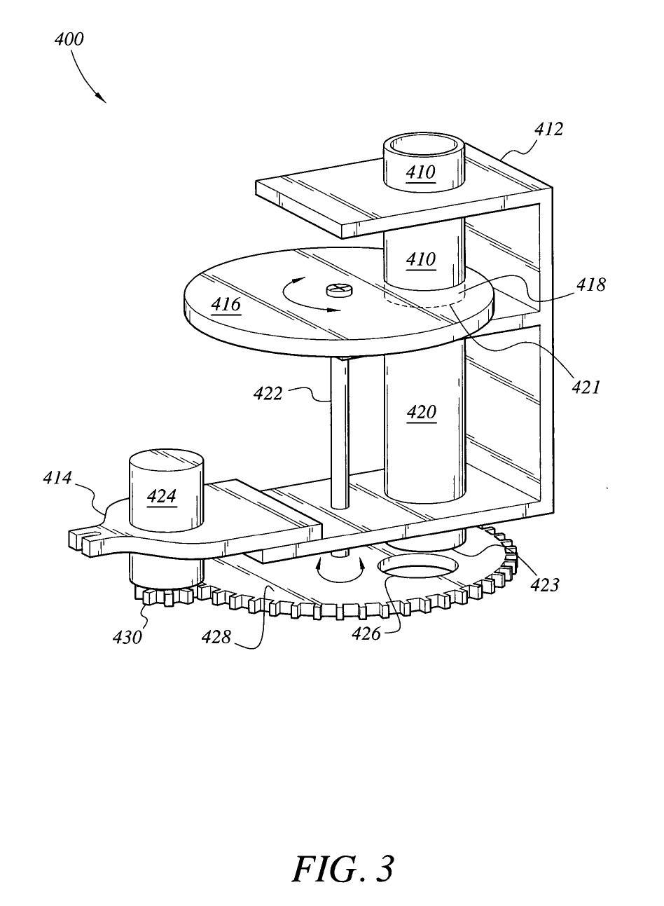

Referring now to FIG. 3, the hopper dispenser assembly 400 comprises a measuring chamber or cup 420, a fill plate 416, a dispenser gear 428, a dispenser motor 424 and a tie shaft 422, all of these components being mounted on a bracket 412. The measuring cup 420 is a tube having a first open end 421 and a second open end 423. The tube, the first end 421 and the second end 423 all have the same diameter. The measuring cup 420, specifically the first end 421, is aligned with and disposed below the hopper rest 410. The fill plate 416 is disposed adjacent the first end 421 of the measuring cup 420 and dispenser gear 428 is disposed adjacent the second end 423 of the measuring cup 420.

Both the fill plate 416 and dispenser gear 428 are flat discs and each has an opening 418, 426, respectively, defined therein. The openings 418, 426 have the same diameter as the first and second ends 421, 423 and tube of the measuring cup 420. The tie shaft 422 connects the fill plate 416 to the dispenser gear 428 in a coaxial, parallel orientation to each other. In this coaxial, parallel orientation, the openings 418, 426, of the fill plate 416 and the dispenser gear 428, respectively, are misaligned or rotationally offset with respect to each other by at least the diameter of the ends 421, 423. Consequentially, when one opening 418, 426 is in alignment with the measuring cup 420 the other opening 426, 418 is positioned out of alignment with the measuring cup 420.

On account of the tie shaft 422, the fill plate 416 moves in unison with the dispenser gear 428. The dispenser gear 428 is triggered to move by the dispenser motor 424. The motor 424 has a gear 430, such as a pinion gear, that engages the dispenser gear 428 to move both the fill plate 416 and dispenser gear 428. The motor 424 is a stepper motor that rotates a sufficient amount to move the openings 418, 426 either into alignment or out of alignment with the measuring cup 420. The motor 424 is mounted on a dispenser motor mount 414 that is joined to the bracket 412.

The hopper dispenser assembly 400 has two positions, a fill position and a dispense position that dispenses the measured amount of powder into the bottle 150. In the fill position, the first end 421 of the measuring cup 420 is aligned with the opening 418 of the fill plate 416, and consequentially uninterruptedly aligned with the hopper rest 410, the hopper transition 310 and the hopper 300. The hopper rest 410 and the hopper transition 310 provide a smooth flow of powder from the hopper 300 into the measuring cup 420. The second open end 423 of the measuring cup 420 abuts the dispenser gear 428, which blocks the powder from falling out of the measuring cup 420, thereby allowing the powder to be retained in the measuring cup 420. In this position, powder is measured for preparing food in response to directions communicated by the volume input controls 216. The powder held in the hopper 300 is agitated down to the measuring cup 420 by the hopper vibrator 310.

In the dispense position, the measured amount of powder is dispensed into the bottle 150. In this position, the first end 421 of the measuring cup 420 abuts the fill plate 416, without gaps, to prevent any more powder from entering the measuring cup 420. The second end 423 is aligned with the opening 426 on the dispenser gear 428, thereby allowing the powder held in the measuring cup 420 to drop into the bottle 150. The bottle 150 is held to the device 100 by a bottle adaptor 450. The bottle adaptor 450 is threaded, allowing the bottle 150 to be screwed onto and securely held to the device 100.

The measuring cup 420 preferably is the same size as a measuring cup found in traditional formula containers, holding about enough formula required to mix with two fluid ounces of water. The measuring cup 420, therefore, is filled and dispensed as many times as is needed to fill the bottle 150 with the appropriate amount of powder for making a specific volume of food as selected on the interface device 200. This method is similar to the traditional method of making formula directly from the formula container, but forgoes the need to manually measure powder.

The motor 424 is triggered to switch the fill position to the dispense position each time the measuring cup 420 is filled and reverts back when the powder is dispensed. The vibrator 310 operates both in the fill position and the dispense position. The vibrator 310 helps powder, such as baby formula powder, to pass out of the hopper 300. The structure of the baby formula powder does not lend itself to easily flow out of the hopper, and the powder can become compacted if pushed out or allowed to drop by gravity. Thus, the vibrator 310 operates for a period of time sufficient to fill the measuring cup 420 during the fill position. The vibrator 310 shuts off when the motor 424 switches between the two positions and then will turn back on for a short period of time to help dispense the powder out of the measuring cup 420 into the bottle 150.

As the powder is dispensed into the bottle 150, water is prepared and dispensed into the bottle 150. The device 100 may have a water reservoir 350 for storing water, or may include provision for another water source disposed outside of, and connected to, the device 100. The drawings show an embodiment with a water reservoir 350 that holds water for multiple preparations of food. The reservoir 350 holds enough water for a twenty-four hour period, or about 81 ounces of water, which is about 150 cubic inches of water.

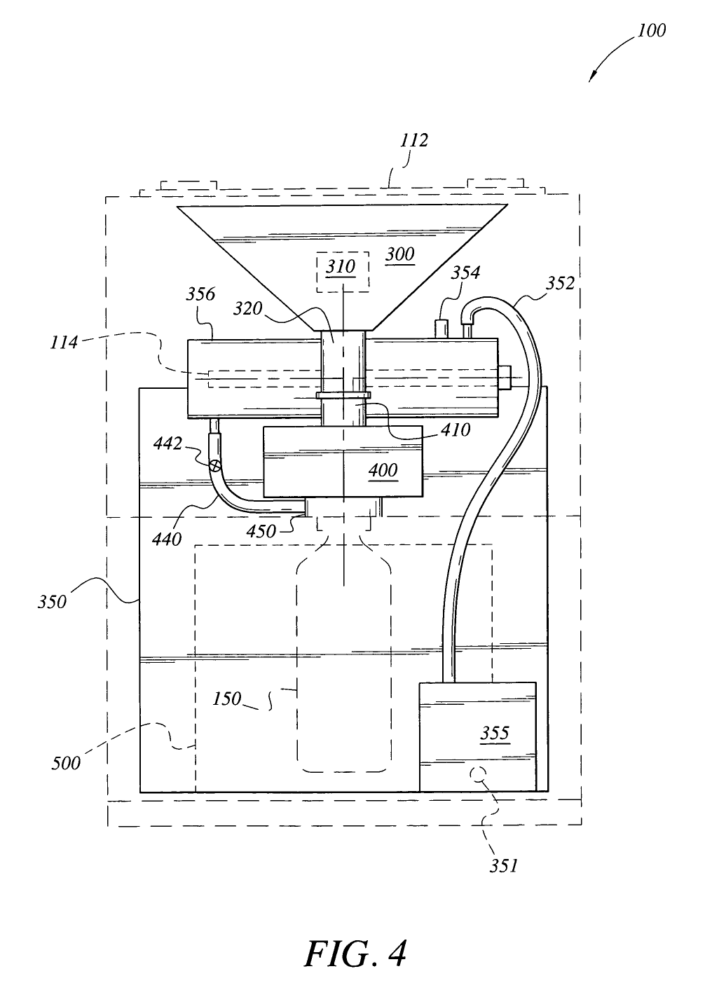

Referring to FIG. 4, once a volume selection is made on the volume input control 216 on the interface device 200, the corresponding volume of water will be measured and pumped out of the reservoir 350 by a water pump 355. In some embodiments, a water filter may be disposed in the device to provide enhanced sanitary conditions. The water pump 355 functions via a timer (not shown) that pumps water received from the reservoir 350 via a flexible tube 351 through a flexible tube 352 into a heating element 356 in which the water is heated to the temperature selected by the temperature input control 214. By default, the water is heated to body temperature, but the temperature input controls 214 can be adjusted to higher or lower temperatures, as desired.

The device 100 measures an exact amount of water corresponding to the selection made on volume input control 216 by controlling the rate of water flow and the time in which the pump 355 is turned on. The pump is selectively turned on by the timer. A restrictor valve 442 disposed on a water outlet tube and a check valve 354 disposed on the heating element 356 control the flow rate and volume of water. The exact volume amount of water is therefore obtained by multiplying the amount of time the pump is turned on with the rate at which the water flows through the device. The equation for the above principle is:

$$Water flow rate \times time pump is operational = measured amount of water .$$

Thus, if the flow rate of water is one ounce per ten seconds, then the pump 355 must be active for twenty seconds to pump a volume of two ounces. The restrictor valve 442 and the check valve 354 not only work in conjunction with each other to control the rate and volume of water in measuring the exact volume of water to dispense, but also function in helping to heat the water by maintaining a constant pressure in the heating element 356. The restrictor 442 may be adjusted to increase or decrease water flow and predictably affect the heating of water.

When the pump 355 is inactive, the check valve 354 is open and air can vent the heating element 356, allowing the remaining water to flow out. The opening of the check valve 354 allows the device 100 to maintain sterile conditions for future use, especially if the heating element 356 is still relatively hot. The heating element 356 includes an immersion heater disposed in a heating chamber through which water is directed to flow and be heated. Prior to water being pumped into the heating element 356, the check valve 354 is open, but once the device 100 is activated to prepare food, the immersion heater pre-heats, and water commences to flow into the heating chamber of the heating element 356, closing the check valve 354 and pressurizing the heating element. Both the heating element 356 and the pump 355 are controlled by electronic timers that maintain the correct water temperature and the appropriate volume as selected on the interface device 200.

A water temperature sensor 532 is used to determine the water temperature and control the timing for the heating of water. The water is dispensed from the heating element 356 as the appropriate water temperature level is reached. When the pump 355 is turned off, the chamber of the heating element 356 is depressurized, and the check valve opens, allowing the remaining water in the heating element to empty out of the heating element 356. The heated water is dispensed out into the bottle 150 by flowing out the water outlet tube 440, which is connected to the bottle adaptor 450. The water outlet tube 440, restrictor 442 and the check valve 354 generally define the portion of the dispenser assembly for dispensing water.

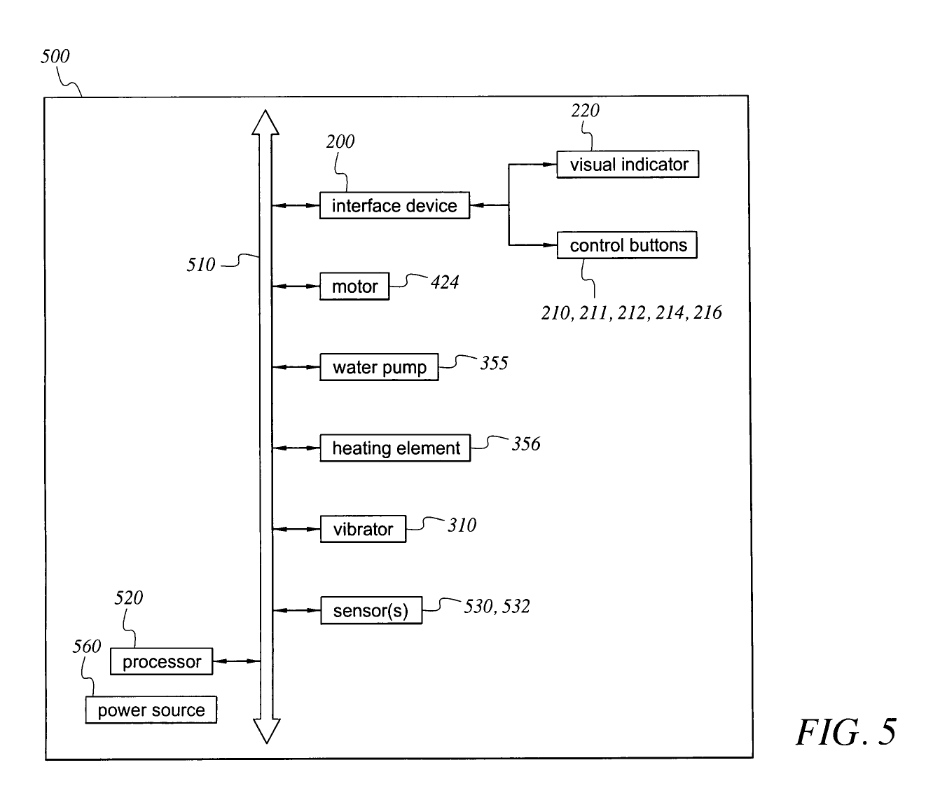

Referring to FIG. 5, the device 100 has an electrical control unit 500 that operates on a power source 560, which may be either inside or outside the device. In the drawing, the power source 560 is includes components disposed within the device 100. The electrical control unit 500 converts 120 volts AC power into DC power. The AC power is used to power the heating element 356, while the DC power operates the motor 424, the vibrator 310 and the pump 355.

The electrical control unit 500 sequences and times the hopper dispenser assembly 400 and the vibrator 310, as well as components for water measuring and water heating, such as the pump 355 and timer (not shown), all via a communication bus 510. The interface device 200, specifically the control buttons 210, 211, 212, 214, 216, the sensor 530 disposed in the reservoir 350 and the water temperature sensor 532, provides inputs to a processor 520 that, in turn, provides output to the heating element 356, motor 424, the vibrator 310, the pump 355 and visual indicators 220.

Once the hopper 300 is filled with powder, the reservoir 350 is filled with water, and the power button 210 is on, the device is fully functional to make numerous food preparations. Thus, the user may then select a volume of powder desired to be prepared, select a temperature at which the food should be prepared, and commence preparing the food by activating the device via the start control button 211, which turns on the visual indicator 220 signifying that the food is brewing. If a different amount of food is desired to be made, the user presses the clear button 212 and makes a new selection. The device 100 then dispenses a measured amount of powder into the bottle and heats and dispenses a measured amount of water in response to the volume selected on the interface device 200. Once brewing is complete, the visual indicator 220 flashes, indicating that brewing is completed. In another embodiment, the device 100 may have a timer that can be programmed to automatically prepare the food at designated times. Once the powder and water are dispensed into the bottle 150 the user removes it and shakes it to thoroughly mix the food.

It is to be understood that the present invention is not limited to the embodiments described above, but encompasses any and all embodiments within the scope of the following claims.

We claim:

1. A baby bottle warming device, comprising:
a housing;
an interface device disposed on the housing and having a plurality of temperature input controls, volume input controls and visual indicators;
a heating element disposed in the housing for heating water;
a hopper disposed in the housing adapted for holding dry powder;
a hopper vibrator attached to the hopper for agitating the dry powder in the hopper for improving flowability of the powder;
a dispenser assembly disposed in the housing for dispensing the dry powder and heated water into a bottle at a temperature and a volume set by the input controls; and
an electrical control unit disposed in the housing and electrically connected to the interface device, the dispenser assembly, the heating element and the hopper vibrator.

2. The baby bottle warming device according to claim 1, wherein the dispenser assembly includes a hopper dispenser assembly for dispensing the dry powder in measured, pre-determined amounts in response to directions disclosed by the volume input controls, the assembly having:
a measuring cup, the cup being a tube having a first end and a second end of uniform diameter;
a fill plate disposed at the first end of the measuring cup, the fill plate being a disc having an opening defined therein having a diameter equal to the diameter of the first end;
a dispenser gear disposed at the second end of the measuring cup, the dispenser gear being a disc having gear teeth and having an opening defined therein, the opening of the dispenser gear having a diameter equal to the diameter of the second end, the opening of the dispenser gear being rotationally offset from the opening of the fill plate;
a dispenser gear motor having a gear engaging the dispenser gear, the dispenser gear motor rotating the dispenser gear; and
a tie shaft connecting the fill plate to the dispenser gear, whereby as the dispenser gear motor rotates the dispenser gear the fill plate simultaneously rotates.

3. A food preparation device, comprising:
a housing;
an interface device disposed on the housing and having a plurality of temperature input controls, volume input controls and visual indicators;
a heating element disposed in the housing for heating water;
a hopper disposed in the housing adapted for holding dry powder;
a hopper vibrator attached to the hopper for agitating the dry powder in the hopper for improving flowability of the powder;
a dispenser assembly disposed in the housing for dispensing the dry powder and heated water into a bottle at a temperature and a volume set by the input controls; and
an electrical control unit disposed in the housing and electrically connected to the interface device, the heating element, the hopper vibrator and the dispenser assembly.

4. The food preparation device according to claim 3, further comprising a water reservoir disposed in the housing.

5. The food preparation device according to claim 4, wherein the water reservoir has a capacity for holding about 81 ounces of water.

6. The food preparation device according to claim 4, wherein the water reservoir has a volume of about 150 cubic inches.

7. The food preparation device according to claim 3, wherein the dispenser assembly includes water outlet tubing adapted for directing the water heated in the heating element into the bottle.

8. The food preparation device according to claim 8, further comprising a restrictor valve disposed in the water outlet tubing for controlling the flow of water out of the outlet tubing.

9. The food preparation device of claim 7, wherein the heating element has a check valve for controlling the flow of water out of the outlet tubing.

10. The food preparation device according to claim 3, further comprising a water pump disposed in the housing for pumping water to the heating element.

11. The food preparation device according to claim 10, further comprising means for activating the pump for a period of time corresponding to a flow rate sufficient to dispense a measured amount of water set by the volume input controls to the heating element.

12. The food preparation device according to claim 3, wherein the dispenser assembly includes a hopper dispenser assembly for dispensing the dry powder in measured, pre-determined amounts in response to directions disclosed by the volume input controls, the assembly having:
a measuring cup, the cup being a tube having a first end and a second end of uniform diameter;
a fill plate disposed at the first end of the measuring cup, the fill plate being a disc having an opening defined therein having a diameter equal to the diameter of the first end;
a dispenser gear disposed at the second end of the measuring cup, the dispenser gear being a disc having gear teeth and having an opening defined therein, the opening of the dispenser gear having a diameter equal to the diameter of the second end, the opening of the dispenser gear being rotationally offset from the opening of the fill plate;
a dispenser gear motor having a gear engaging the dispenser gear, the dispenser gear motor rotating the dispenser gear; and
a tie shaft connecting the fill plate to the dispenser gear, whereby as the dispenser gear motor rotates the dispenser gear the fill plate simultaneously rotates;
wherein the first end of the measuring cup is aligned with the opening of the fill plate and the second end of the measuring cup is out of alignment with the opening of the dispenser gear plate in order to fill the measuring cup with dry powder from the hopper; and
wherein after filling the measuring cup, the dispenser gear motor turns the dispenser gear and simultaneously turns the fill plate, misaligning the first end of the measuring cup with the opening of the fill plate and aligning the second end of the measuring cup with the opening of the dispenser gear plate in order to dispense the dry powder out of the device.

13. The food preparation device according to claim 12, wherein further comprising a bottle adaptor for holding a bottle, the bottle adaptor being aligned with the second end of the measuring cup, thereby allowing the bottle to receive the dry powder.

14. The food preparation device according to claim 3, wherein the temperature input controls is set by default to body temperature.

15. The food preparation device according to claim 3, wherein the hopper has a volume adapted for holding sufficient dry powder for more than one food preparation.

16. A method for preparing food using a food preparation device, comprising the steps of:
filling a water reservoir in the device with water;
filling a hopper in the device with powder;
selecting a volume of food that is desired to be prepared;
selecting a temperature at which the food is desired to be prepared;
activating the device;
dispensing a measured amount of powder in response to the volume selected into a bottle;
heating a measured amount of water in response to the volume selected; and
dispensing the water into the bottle after the water is heated to the selected temperature.
